(19) United States
(12) Patent Application Publication
(10) Pub. No.: US 2011/0170131 A1
(43) Pub. Date: Jul. 14, 2011

(54) IMAGE FORMING APPARATUS, PRINTING SYSTEM AND PRINTING METHOD

(75) Inventor: Atsushi Kondo, Itami-shi (JP)

(73) Assignee: Konica Minolta Business Technologies, Inc, Tokyo (JP)

(21) Appl. No.: 13/119,913

(22) PCT Filed: Aug. 11, 2009
(86) PCT No.: PCT/JP2009/003853

§ 371 Date: Mar. 18, 2011

(30) Foreign Application Priority Data
Sep. 19, 2008 (JP) 2008-240940

(51) Int. Cl. G06K 15/02

(52) U.S. Cl. 358/1.14

(57) ABSTRACT

An image forming apparatus that executes a waiting print job and charges for the execution of the waiting print job. The waiting print job is inputted by a user and is kept from being executed until an execution instruction is inputted in the image forming apparatus by the user. The image forming apparatus includes: an allocation part that analyzes the waiting print job when the waiting print job is inputted, determines a billing amount therefor based on a result of the analysis and allocates, for the waiting print job, a budget amount equivalent to the determined billing amount; and an execution part that performs the execution when the budget amount has been allocated. When the waiting print job is inputted, the allocation part performs the allocation regardless of whether the execution instruction is inputted.

### REFERENCE TO RELATED APPLICATIONS

This application is a national stage application under 35 USC 371 of International Application No. PCT/JP2009/003853, filed Aug. 11, 2009, which claims the priority of Japanese Application No. 2008-240940, filed Sep. 19, 2008, the contents of which prior applications are incorporated herein by reference.

### FIELD OF THE INVENTION

The present invention relates to a billing management technique used in a printing system that performs billing printing, and in particular to a billing management technique used while the printing system keeps a print job from being executed until an execution instruction is received.

### BACKGROUND OF THE INVENTION

In recent years, image forming apparatuses such as copying machines having secure print mode functions have been widely used.

According to a printing form called a “secure print mode”, a print job is inputted in an image forming apparatus from a user, the print job is kept from being executed until an execution instruction for executing the print job is inputted by the user, and the print job is executed in response to the execution instruction inputted by the user when he wishes the print job to be executed.

Thus, the user can make a selection as to when the print job is executed in accordance with surrounding condition of the image forming apparatus. Therefore, in the case of printing a highly confidential important document, the user can cause the image forming apparatus to execute the print job when no one is around the image forming apparatus. Thus, it is possible to effectively prevent secrecy from leaking due to the important document being exposed to others when the print job is executed.

[Patent Literature 1]

Japanese Patent Application Publication No. 2008-186407

### SUMMARY OF THE INVENTION

However, in a case where charging for executing a print job is performed and an upper limit of an amount of money for printing that can be used in a predetermined time period is set for a user, the following problem may arise. That is, because the user causes another print job to be executed and charging for the execution of the another print job is performed while a print job to be executed in the secure print mode (secure print job) is kept from being executed, an amount of money necessary for executing the secure print job is possibly insufficient when the user gives an execution instruction for executing the secure print job. In this case, the print job cannot be executed.

The present invention has been achieved in view of the above problem, and an aim thereof is to provide an image forming apparatus described below, a printing system including the same and a printing method. The image forming apparatus is capable of effectively preventing insufficiency of an amount of money necessary for executing a print job while keeping the print job from being executed until an execution instruction is received.

In order to solve the above problem, one aspect of the present invention is an image forming apparatus that executes a waiting print job and charges for the execution of the waiting print job, the waiting print job being a print job that is inputted by a user and kept from being executed until an execution instruction is inputted by the user, the image forming apparatus comprising: a determination part operable, when the waiting print job is inputted, to analyze the waiting print job and determine a billing amount of the waiting print job based on a result of the analysis; an allocation part operable to allocate, for the waiting print job, a budget amount equivalent to the determined billing amount; and an execution part operable, when the execution instruction is inputted and the budget amount has been allocated, to perform the execution, wherein when the waiting print job is inputted, the allocation part performs the allocation regardless of whether the execution instruction is inputted.

Also, another aspect of the present invention is a print method used in an image forming apparatus, the print method comprising: a determination step of, when a user inputs a waiting print job that is kept from being executed until an execution instruction is inputted by the user, analyzing the waiting print job, and determining a billing amount of the waiting print job based on a result of the analysis; an allocation step of allocating, for the waiting print job, a budget amount equivalent to the determined billing amount; and an execution step of executing, when the execution instruction is inputted and the budget amount is allocated, the waiting print job, wherein when the waiting print job is inputted, the allocation step performs the allocation regardless of whether the execution instruction is inputted.

Also, yet another aspect of the present invention is a printing system that includes a billing server that manages an upper limit of an amount of money that is set for each user and is for executing one or more print jobs inputted by the user, and an image forming apparatus that executes a waiting print job and causes the billing server to charge for the execution of the waiting print job, the waiting print job being a print job that is, after being inputted, kept from being executed until an execution instruction is inputted by the user, the image forming apparatus comprising: a determination part operable, when the waiting print job is inputted, to analyze the waiting print job and determine a billing amount of the waiting print job based on a result of the analysis; an allocation request part operable to make an allocation request to the billing server for allocating, for the waiting print job, a budget amount equivalent to the determined billing amount; and an execution part operable, when the execution instruction is inputted and the budget amount has been allocated by the billing server, to perform the execution, the billing server comprising: a budget allocation part operable, upon receiving the allocation request from the image forming apparatus, to judge whether or not a sum of budget amounts that have been allocated and the budget amount to be allocated exceeds the set limit, and when judging negatively, allocate the budget amount so as not to be used for executing another one or more of the print jobs other than the waiting print job; and a notification part operable to notify the image forming apparatus of whether or not the budget amount is allocated for the waiting print job, wherein when the waiting print job is inputted, the allocation request part makes the allocation request regardless of whether the execution instruction is inputted.

According to the present invention, with the above-described structures, when a waiting print job that is kept from being executed until an execution instruction is inputted is received, a budget amount of the billing amount for the waiting print job is allocated regardless of whether the execution instruction of the waiting print job is inputted. Therefore, it is possible to effectively avoid a situation that the waiting print job cannot be executed due to insufficiency of an amount of money for executing the waiting print job during a time between the print job being received and the execution instruction of which being received.

### BRIEF DESCRIPTION OF THE DRAWINGS

FIG. 1 shows an exemplary structure of a printing system 1 pertaining to a first embodiment;

FIG. 2 shows a block diagram showing a structure of an image forming apparatus 100;

FIG. 3 shows a concrete example of billing information;

FIG. 4 shows a concrete example of a waiting print job table;

FIG. 5 shows a block diagram showing a structure of a billing server 103;

FIG. 6 shows a concrete example of a balance management table;

FIG. 7 shows a concrete example of a billing ticket management table;

FIG. 8 shows a block diagram showing a structure of an authentication server 104;

FIG. 9 shows a concrete example of user authentication management information;

FIG. 10 shows a flowchart showing an operation of print control processing performed by a controller 14;

FIG. 11 is flowchart showing operations of billing ticket acquisition processing of Step S1005;

FIG. 12 is a flowchart showing operations of stored ticket update processing of Step S1009;

FIG. 13 is a flowchart showing operations of billing ticket issuance processing performed by the billing server 103;

FIG. 14 is a flowchart showing operations of issued billing ticket adjusting processing performed by the billing server 103;

FIG. 15 shows an exemplary structure of a printing system pertaining to a second embodiment;

FIG. 16 shows a structure of a job management apparatus 200;

FIG. 17 shows a concrete example of print job management information;

FIG. 18 is a flowchart showing operations of the print job management processing performed by the job management apparatus 200;

FIG. 19 is a flowchart showing operations of the transferred print job execution processing performed by a controller 24; and

FIG. 20 shows a concrete example of storage period specification table.

### DETAILED DESCRIPTION OF THE INVENTION

Structure

(1) Structure of Printing System 1

The following describes a printing system 1 pertaining to a first embodiment.

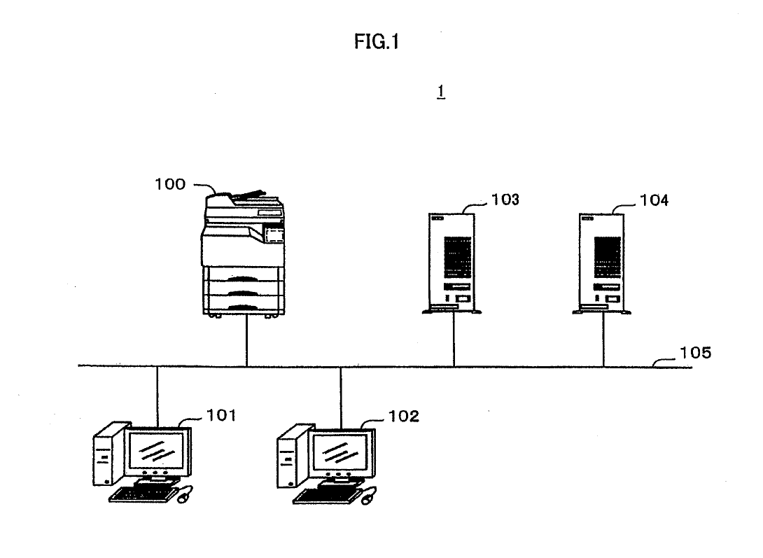

FIG. 1 shows an exemplary structure of the printing system 1 of the first embodiment.

As shown in FIG. 1, the printing system 1 is composed of an image forming apparatus 100, personal computers (hereinafter, referred to as “PCs”) 101 and 102, a billing server 103 and an authentication server 104.

The image forming apparatus 100, the PCs 101 and 102, the billing server 103 and the authentication server 104 are connected to one another via a LAN (Local Area Network) 105.

(2) Structure of Image Forming Apparatus 100

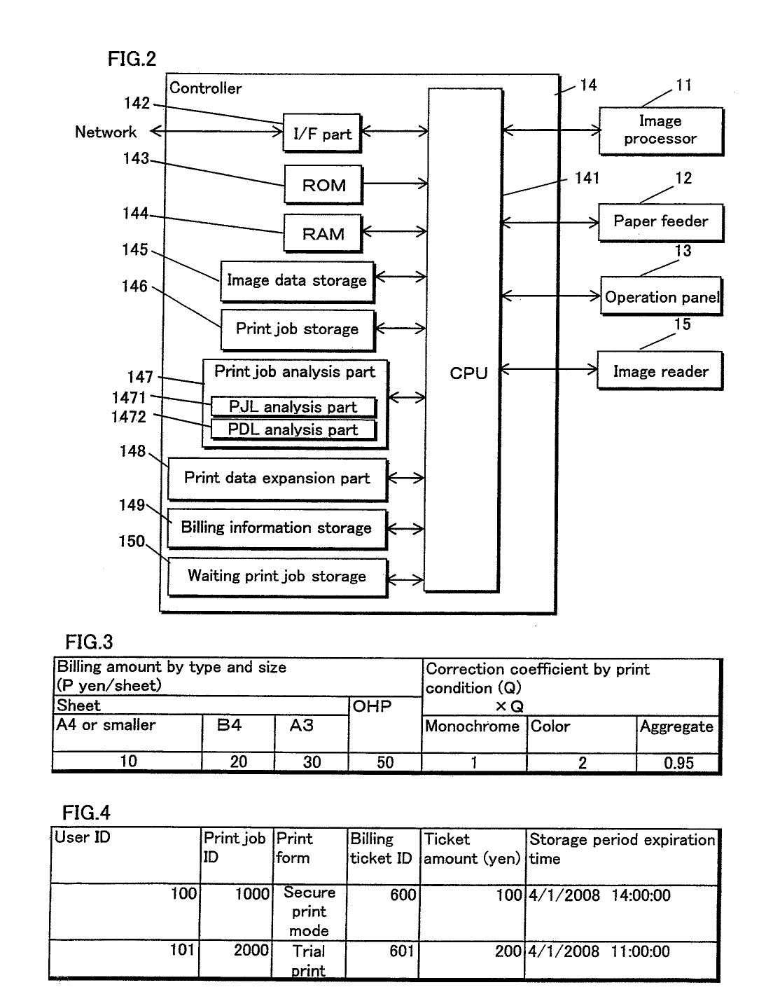

FIG. 2 is a block diagram showing the structure of the image forming apparatus 100. As shown in FIG. 2, the image forming apparatus 100 is composed of an image processor 11, a paper feeder 12, an operation panel 13, a controller 14 and an image reader 15.

The image processor 11 performs print processing that forms an image on a recording sheet supplied from the paper feeder 12 based on image data inputted from the controller 14.

The operation panel 13 includes a plurality of input keys and a liquid crystal display part. On a surface of the liquid crystal display part is layered a touch panel. The operation panel 13 receives an instruction from the user via a touch input from the touch panel or a key input via the input keys, and notifies the controller 1 14 of the instruction received from the user.

The image reader 15 is composed of an image input device such as a scanner. The image reader 15 reads information such as a character and/or a geometric figure that are written on the recording sheet such as paper, and forms image data.

The controller 14 includes, as main elements, a CPU 141, a communication interface (I/F) part 142, a ROM 143, a RAM 144, an image data storage 145, a print job storage 146, a print job analysis part 147, a print data expansion part 148, a billing information storage 149 and a waiting print job storage 150, for example.

The I/F part 142 is an interface for connection with the LAN such as a LAN card and a LAN board.

The ROM 143 stores therein programs such as a program for controlling operations of print control processing (described later) in addition to a program necessary for executing the print processing, a program (e.g. program that analyzes PDL (Page Description Language)) necessary for analyzing the print job.

The RAM 144 is used as a work area at the time of a program execution by the CPU 141.

The image data storage 145 stores therein image data for printing that is input via the I/F part 142 or the image reader 15 and is expanded to a bitmap data by the print data expansion part 148.

The print job storage 146 stores therein print jobs transmitted from the PCs 101 and 102 in one-to-one correspondence with identifiers of the print jobs (here, “print job IDs”).

The “print job” is data generated by the PCs 101 and 102, and includes print data to be printed, a print job identifier such as a print job ID, print form information showing whether a print form is a “normal print mode”, a “secure print mode” or a “trial print mode”, print condition information showing print condition of the print data (e.g. specification of the number of copies to be printed and specification of a size of the sheet), and authentication information (e.g. a user ID and a password) of the user that makes a print request.

The print data is written in the PDL, and the other information pieces are written in PJL (“Printer Job Language” that has been developed by the Hewlett-Packard Company for controlling the print job).

The print form information, the print condition information and user authentication information are inputted by the user via a screen (not depicted) displayed in GUIs (Graphic user Interfaces) of the PCs 101 and 102.

The “normal print mode” is a print form in which, upon receiving an input of the print job, the image forming apparatus 100 executes the print job and performs a print output regardless of whether an execution instruction for executing the print job is inputted. The “secure print mode” is a print form in which, upon receiving an input of the print job, the image forming apparatus 100 keeps the print job from being executed until the user that makes a print request gives the execution instruction for executing the print job and inputs the user authentication information, and the image forming apparatus 100 executes the print job upon receiving the execution instruction for executing the print job. The “trial print mode” is similar to the “secure print mode”, and is a print form in which, upon receiving the input of the print job, the image forming apparatus 100 performs partial print output on the print data of the print job (in this example, only a first page is printed out).

The print job analysis part 147 includes a PJL analysis part 1471 and a PDL analysis part 1472, and analyzes the print jobs transmitted from the PCs 101 and 102.

The PJL analysis part 1471 analyzes types of information pieces written in the PJL.

The PDL analysis part 1472 analyzes the print data written in the PDL, and generates intermediate data for expanding the print data to the bitmap data.

The print data expansion part 148 expands, to pages of the bitmap data, the intermediate data generated in the print job analysis part 147.

The analysis and expanding processing of the print data generates information necessary for calculating a billing amount, such as the number of pages of the print data, and whether the printed data is to be printed in monochrome or color.

The billing information storage 149 stores therein billing information acquired by the billing server 103.

The billing information is information that shows a correspondence between the print condition and the billing amount. The CPU 141 calculates the billing amount for the print job based on the billing information, print condition information included in the print job and the number of expanded pages of the print data.

FIG. 3 shows a concrete example of the billing information. The example shown in FIG. 3 is a correspondence between a type and a size of the recording sheet and a billing amount (P yen) per recording sheet having the type and the size. Also, in this example, a correction coefficient (Q) is specified in accordance with whether or not the print condition is a monochrome printing, the color printing or an aggregate printing. The billing amount per recording sheet is obtained by multiplying P by Q.

For example, when the print condition shown by the print condition information of the print job is that “the type of the recording sheet is sheet, the size of the recording sheet is A4, and a print form is monochrome print mode”, and the number of expanded pages is 10, P that corresponds to this print condition is 10, and Q is 1 according to the billing information shown in FIG. 3. Therefore, 10 yen is obtained, as the billing amount per recording sheet, by multiplying P by Q.

Since the number of expanded pages is 10, 100 yen is obtained, as the billing amount for the print job, by multiplying 10 yen (the billing amount per recording sheet) by 10 (the number of expanded pages).

The waiting print job storage 150 stores therein a waiting print job table.

The waiting print job table is a table showing a list of print jobs each: having a print form of the “secure print mode” or the “trial print mode”; and being kept from being executed until the user makes the execution instruction. Specifically, the waiting print job table shows a correspondence among the ID of the user that makes the execution instruction of the print job, the print job ID, the print form of the print job, an ID of a billing ticket issued by the billing server 103 for the print job, the amount of the billing ticket and a storage period expiration time of the billing ticket.

A storage period of the billing ticket is pre-specified in accordance with the print form of the print job (e.g. six hours when the print form is the “secure print mode”, and one hour when the print form is the “trial print mode”). A time at which a predetermined storage period has elapsed since the billing ticket is received is calculated as a billing ticket storage period expiration time by the CPU 141, and is stored in the waiting print job table.

FIG. 4 shows a concrete example of the waiting print job table. In the example shown in FIG. 4, a print job (a print job ID of 1000) in the secure print mode requested by the user having a user ID of 100 and a print job (a print job ID of 2000) in the trial print mode requested by a user having a user ID of 101 are kept from being executed. A 100 yen worth of a billing ticket is allocated to the print job having the print job ID of 1000 as a budgeted billing amount for the print job. A storage period of this billing ticket expires at 14 o'clock on Apr. 1, 2008. A 200 yen worth of a billing ticket is allocated to the print job having the print job ID of 2000 as a budgeted billing amount for the print job. A storage period of this billing ticket expires at 11 o'clock on Apr. 1, 2008.

The CPU 141 reads a necessary control program from the ROM 143 to analyze the print job, and controls the image processor 11, the paper feeder 12 and the image reader 15, for example, to smoothly control operations of the print processing. Also, the CPU 141 controls the operations of the print control processing (described later)

(3) Structure of Billing Server 103

FIG. 5 is a block diagram showing the structure of the billing server 103. As shown in FIG. 5, the billing server 103 includes, as main elements, a CPU 21, a communication interface (I/F) part 22, a ROM 23, a RAM 24, a billing information storage 25 and a billing management information storage 26, for example.

The I/F part 22 is an interface for connection with the LAN such as the LAN card and the LAN board.

The ROM 23 includes programs, for example, necessary for executing after-mentioned operations of the billing ticket issuance processing and the issued billing ticket adjusting processing.

The RAM 24 is used as a work area at the time of a program execution by the CPU 21.

The billing information storage 25 stores therein the billing information.

The billing management information storage 26 stores therein a balance management table and the billing ticket management table.

The balance management table is a table showing a correspondence among a balance of a pre-provided amount of money for printing, the user and a billing ticket allocated as a budgeted billing amount for the print job intended for execution by the user. Here, the amount of money for printing is pre-provided, with each user who is registered in the authentication server 104 as a person permitted to use the image forming apparatus 100.

A predetermined amount of money is provided with each user regularly as the amount of money for printing. For example, 1000 yen is provided with the user per month. For a month after 1000 yen is provided, the billing amount necessary for the execution of the print job is decremented from the predetermined amount of money (in this example, 1000 yen) each time the print job is executed. After the month has elapsed, the balance returns to 1000 yen.

Thus, it is possible to manage the amount of money consumed by the user for printing so as to fall within the predetermined amount of money.

The billing ticket is a ticket issued for the image forming apparatus 100 from the billing server 103 in order to adjust the billing amount for the print job when each user has the image forming apparatus 100 to execute the print job. Specifically, the billing ticket is information showing an amount of money equivalent to the billing amount.

The billing ticket is issued after the billing amount is subtracted from the balance of the amount of money for printing pre-provided with the user. Therefore, after the issuance of the billing ticket, the user is unable to use the amount of money indicated by the billing ticket from the balance, for executing another one or more print jobs. Therefore, a budget amount equivalent to the billing amount for the print job relating to the billing ticket is allocated by the issuance of the billing ticket.

When the image forming apparatus 100 notifies the billing server 103 of an ID of the billing ticket upon completion of the execution of the print job, information on the billing ticket is deleted from the balance management table.

When the print job is not executed, on the other hand, the image forming apparatus 100 returns the billing ticket of the print job to the billing server 103. After that, the amount allocated as the budget amount equivalent to the billing amount for the print job is added to the balance of the user in the balance management table. Then, the information on the billing ticket of the print job is deleted from the balance management table.

Thus, the adjusting processing of the billing amount for the print job is complete.

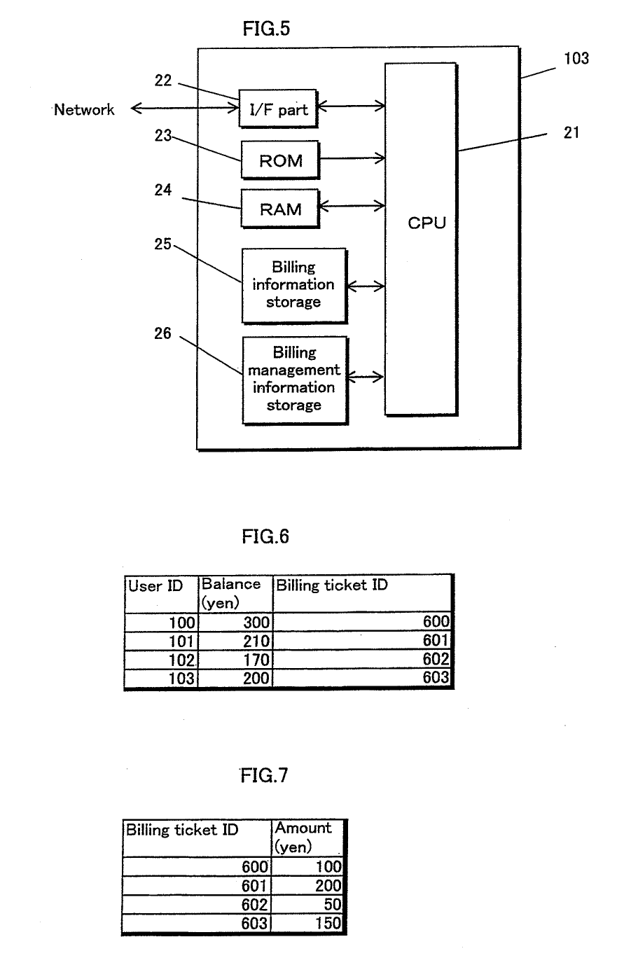

FIG. 6 shows a concrete example of the balance management table. FIG. 6 shows a balance of the amount of money for printing pre-provided with each of the users respectively having the user IDs of 101 to 103, and an ID of the billing ticket allocated as the budget amount equivalent to the billing amount for the print job intended for execution by the user.

The billing ticket management table is a table showing a correspondence between the billing ticket issued for the image forming apparatus 100 by the billing server 103 and an amount of money indicated by the billing ticket.

FIG. 7 shows a concrete example of the billing ticket management table. FIG. 7 shows a correspondence between each of the billing ticket IDs and an amount of money indicated by a billing ticket having a corresponding billing ID.

The CPU 21 reads, from the ROM 23, the programs necessary for executing the operations of the billing ticket issuance processing and the issued billing ticket adjusting processing, for example, and controls execution of the operations of the billing ticket issuance processing (described later) and the issued billing ticket adjusting processing (described later), for example.

(4) Structure of Authentication Server 104

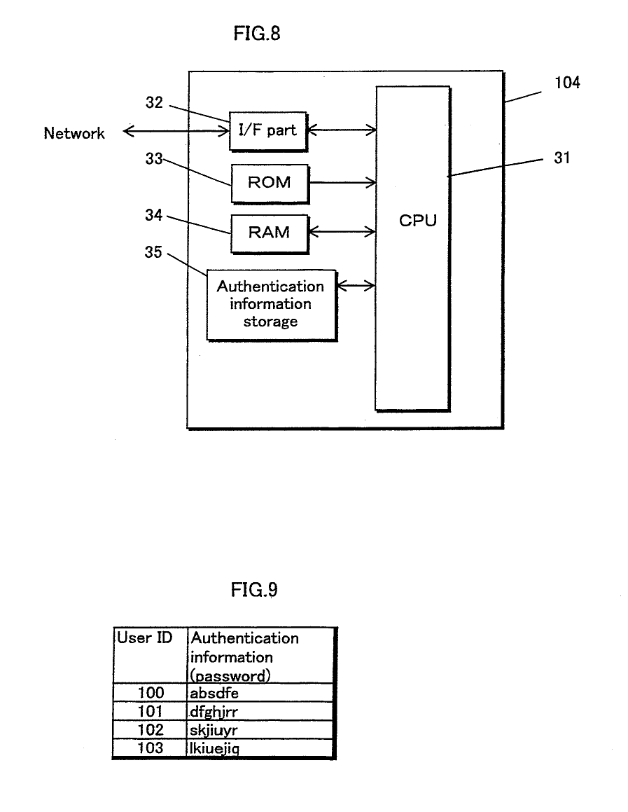

FIG. 8 shows a block diagram showing the structure of the authentication server 104.

The authentication server 104 includes, as main elements, a CPU 31, a communication interface (I/F) part 32, a ROM 33, a RAM 34 and an authentication information storage 35, for example.

The I/F part 32 is an interface for connection with the LAN such as the LAN card and the LAN board.

The ROM 33 stores therein programs such as a program necessary for executing the authentication processing of the user of the image forming apparatus 100.

The RAM 34 is used as a work area at the time of the program execution by the CPU 31.

The information storage 35 stores therein user authentication management information.

The user authentication management information is information showing a correspondence between the user ID of each user of the image forming apparatus 100 and a password.

FIG. 9 shows a concrete example of the user authentication management information.

The CPU 31 reads, from the ROM 33, the program necessary for executing the user authentication processing of the image forming apparatus 100, and executes the user authentication processing.

Specifically, in the after-mentioned print control processing, upon receiving a request for the user authentication processing from the image forming apparatus 100, the CPU 31 receives the user ID and the password as the user authentication information from the image forming apparatus 100, and judges whether or not the received user ID and the received password respectively match the user ID and the password included in the user authentication management information. When judging that the received user ID and the received password respectively match the user ID and the password included in the user authentication management information, the CPU 31 notifies the image forming apparatus 100 that the user is authenticated. When judging that the received user ID and the received password do not respectively match the user ID and the password included in the user authentication management information, on the other hand, the CPU 31 notifies the image forming apparatus 100 that the user is not authenticated.

Operations

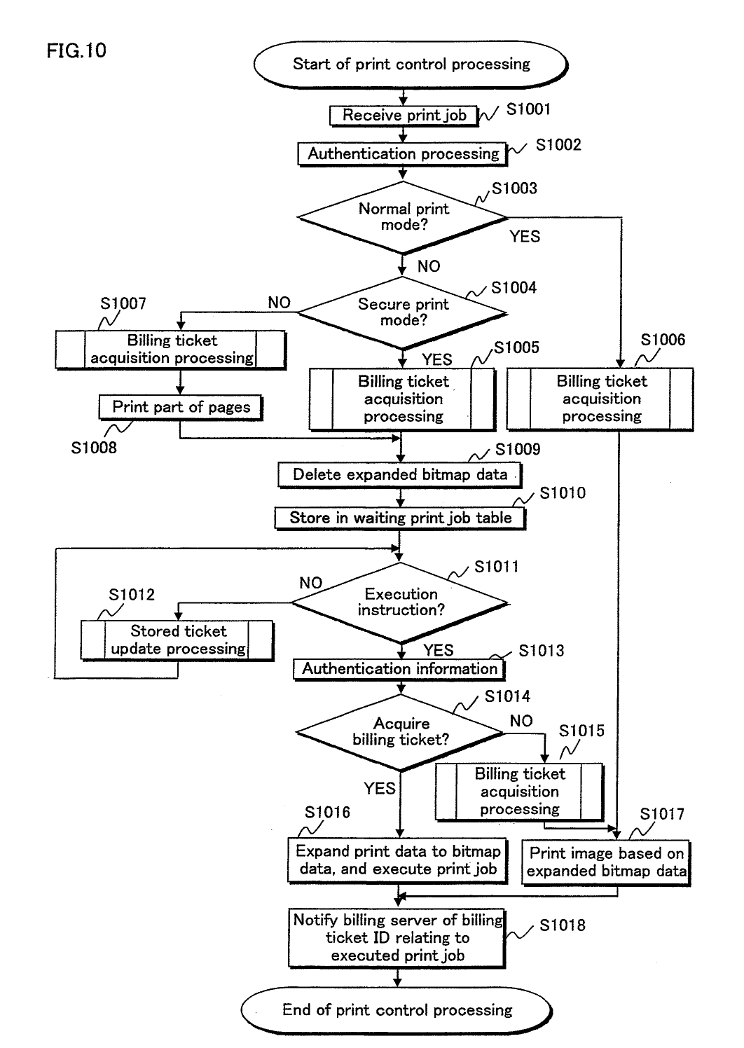

The following describes operations of the print control processing performed by the controller 14. FIG. 10 is a flowchart showing the above-described operations.

Upon receiving the print job transmitted from the PC 101 or the PC 102 via the I/F part 142 (Step S1001), the controller 14 analyzes types of information pieces written in the PJL that are included in the received print job via the print job analysis part 147 to acquire the print job ID, the print form information, the print condition information and the user authentication information. Subsequently, the controller 14 notifies the authentication server 104 of the user ID and the password indicated by the acquired user authentication information via the I/F part 142, makes a request for the user authentication processing and stores, in the print job storage 146, the received print job in correspondence with the print job ID (Step S1002).

Upon receiving the notification that the user is authenticated from the authentication server 104, the controller 14 judges whether the print form indicated by the acquired print form information is the normal print mode or not (Step S1003).

When the print form is not the normal print mode (Step S1003: NO), the controller 14 further judges whether or not the print form is the secure print mode (Step S1004). When the print form is the secure print mode (Step S1004: YES), the controller 14 performs the after-mentioned billing ticket acquisition processing to acquire the billing ticket of the print job (Step S1005) and deletes bitmap data expanded in the billing ticket acquisition processing (Step S1009). Subsequently, the controller 14 calculates the storage period expiration time for the acquired billing ticket. Then, the controller 14 stores, in the waiting print job table stored in the waiting print job storage 150, the user ID, the print job ID, the print form, the billing ticket ID acquired in Step S1005, an amount of money indicated by the billing ticket, and the storage period expiration time calculated for the billing ticket, in correspondence with one another (Step S1010). Here, the user ID, the print job ID and the print form are included in the received print job. Subsequently, the controller 14 monitors whether or not the execution instruction of the print job is given (Step S1011).

The execution instruction of the print job is given, for example, when the user selects a selection button of the secure print mode or the trial print mode displayed in the GUI on the liquid crystal display of the operation panel 13, and selects a corresponding print job from the print job list displayed in the GUI on the liquid crystal display according to the selection of the selection button. Here, in the print job list that is created based on the waiting print job table, the user ID is displayed in correspondence with the print job ID.

When the execution instruction of the print job is given (Step S1011: YES), the controller 14 causes the liquid crystal display part of the operation panel 13 to display a message that prompts an input of the user authentication information. Subsequently, upon receiving the input of the user ID and the password from the operation panel 13, the controller 14 notifies the authentication server 104 of the inputted user ID and the inputted password via the I/F part 142, and makes a request for the authentication processing of this user (Step S1013). When the authentication server 104 performs the user authentication by confirming that the notified user ID and the notified password respectively match the user ID and the password included in the user authentication management information, the controller 14 judges whether or not there is any billing ticket of the print job, with reference to the waiting print job table stored in the waiting print job storage 150 (Step S1014). When judging that there is the billing ticket (Step S1014: YES), the controller 14 reads the print job from the print job storage 146, analyzes the print data via the print job analysis part 147, expands the print data to the bitmap data via the print data expansion part 148, and executes the print job by causing the image forming apparatus 100 to print the image based on the bitmap data (Step S1016). Subsequently, the controller 14 notifies the billing server 103 of the billing ticket ID relating to the executed print job together with deleting the information on the print job from the waiting print job table (Step S1018).

When the result of the judgment in Step S1003 shows that the print form is the normal print mode (Step S1003: YES), the controller 14 performs the after-mentioned billing ticket acquisition processing to acquire the billing ticket of the print job (Step S1006). Then, the controller 14 causes the image forming apparatus 100 to print the image based on the bitmap data expanded in the billing ticket acquisition processing (Step S1017), and proceeds to the processing of step S1018. In this case, since the print job is not stored in the waiting print job table, the print job is not deleted from the print job table.

When the result of the judgment in Step S1004 shows that the print form is not the secure print mode (i.e. trial print mode) (Step S1004: NO), the controller 14 performs the after-mentioned billing ticket acquisition processing to acquire the billing ticket of the print job (Step S1007), causes the image forming apparatus to print part of the print data (e.g. a first page) expanded in the billing ticket acquisition processing (Step S1008) and proceeds to processing of Step S1009.

When the execution instruction of the print job is not given in Step S1011 (Step S1011: NO), the controller 14 performs stored ticket update processing (described later) (Step S1012).

When judging that there is no billing ticket of the corresponding print job in Step S1014 (Step S1014: NO), the controller 14 proceeds to processing of Step S1017 after performing the billing ticket acquisition processing (Step S1015).

Note that when the authentication is not performed in Step S1002 and Step S1013, the controller 14 stops the execution of the print job, and terminates the print control processing.

The following describes the operations of the billing ticket acquisition processing of Step S1005 to Step S1007 and Step S1015. The operations are similar to one another. FIG. 11 is a flowchart showing the above-stated operations.

The controller 14 analyzes the print data via the analysis part 147 to generate intermediate data, and expands the generated intermediate data to pages of the bitmap data via the print data expansion part 148 (Step S1101). Subsequently, the controller 14 calculates the billing amount for the received job based on the billing information stored in the billing information storage 149, the acquired print condition information and the number of expanded pages of the print data (Step S1102). Then, the controller 14 notifies, via the I/F part 142, the billing server 103 of the user ID acquired from the print job, makes a request for issuance of the billing ticket indicating the calculated billing amount (Step S1103), and acquires the billing ticket issued from the billing server 103 according to the request via the I/F part 142 (Step S1104).

Note that when the billing server 103 notifies that the billing ticket cannot be issued in the after-mentioned billing ticket issuance processing, the controller 14 stops the execution of the print job, and terminates the print control processing of the print job.

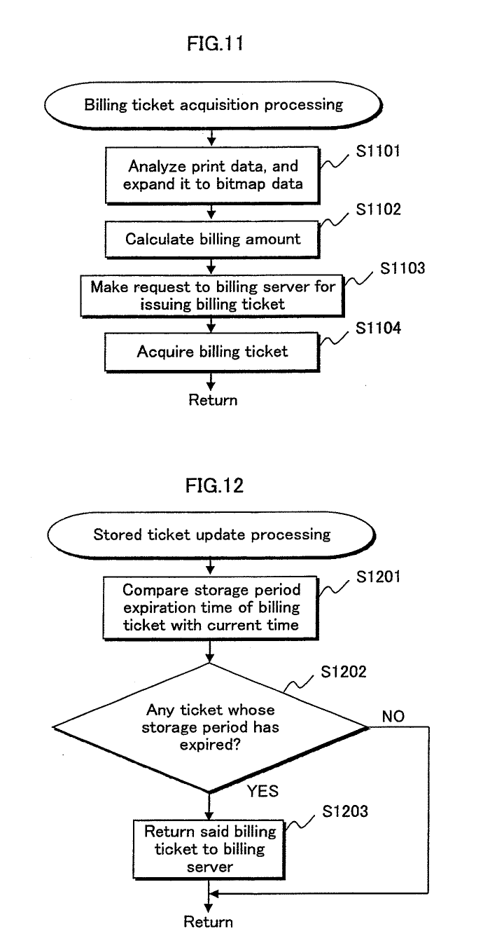

The following describes operations of the stored ticket update processing of Step S1012. FIG. 12 is a flowchart showing the above-stated operations.

The controller 14 acquires a current time, and compares the storage period expiration time of each billing ticket shown in the waiting print job table stored in the waiting print job storage 150 with the current time (Step S1201). Subsequently, the controller 14 judges whether or not there is any billing ticket whose storage period has expired (Step S1202). When judging that there is such a billing ticket (Step S1202: YES), the controller 14 notifies, via the I/F part 142, the billing server 103 of the user ID corresponding to the billing ticket, and returns the billing ticket to the billing server 103 (Step S1203). Then, the controller 14 deletes the information on the billing ticket (information on the billing ticket ID, the amount of money corresponding to the billing ticket and the storage period expiration time) from the waiting print job table.

The following describes the operations of the billing ticket issuance processing performed by the billing server 103 in accordance with the request for the issuance of the billing ticket from the controller 14 in Step S1103 shown in FIG. 11.

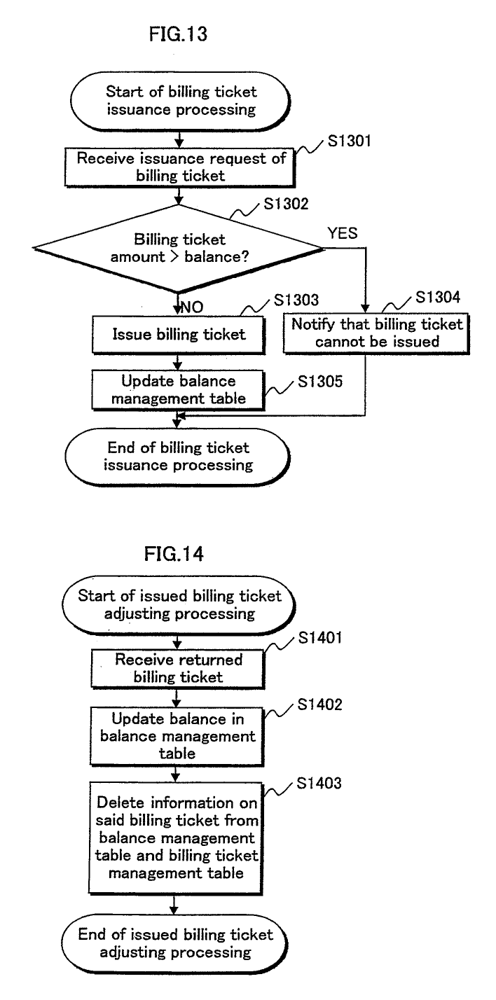

FIG. 13 is a flowchart showing the above-mentioned operations.

Upon receiving the request for the issuance of the billing ticket transmitted from the controller 14 in Step S1103 shown in FIG. 11 (Step S1301), the billing server 103 judges whether or not the amount of money indicated by the billing ticket exceeds the balance of the amount of money for printing pre-provided with the user having the user ID notified from the controller 14, with reference to the balance management table stored in the billing management information storage 26 (Step S1302). When judging that the amount of money indicated by the billing ticket does not exceed the balance (Step S1302: NO), the billing server 103 generates a billing ticket indicating the requested amount of money, and issues the billing ticket to the controller 14 (Step S1303). Subsequently, the billing server 103 updates the balance of the user in the balance management table to an amount of money obtained by subtracting the amount of money indicated by the issued billing ticket from the balance (Step S1305).

Also, when judging that the amount of money indicated by the billing ticket exceeds the balance (Step S1302: YES), the billing server 103 notifies the controller 14 that the billing ticket cannot be issued (Step S1304).

The following describes the operations of the issued billing ticket adjusting processing performed by the billing server 103 when the billing ticket is returned to the billing server 103 from the controller 14 in Step S1203 shown in FIG. 12.

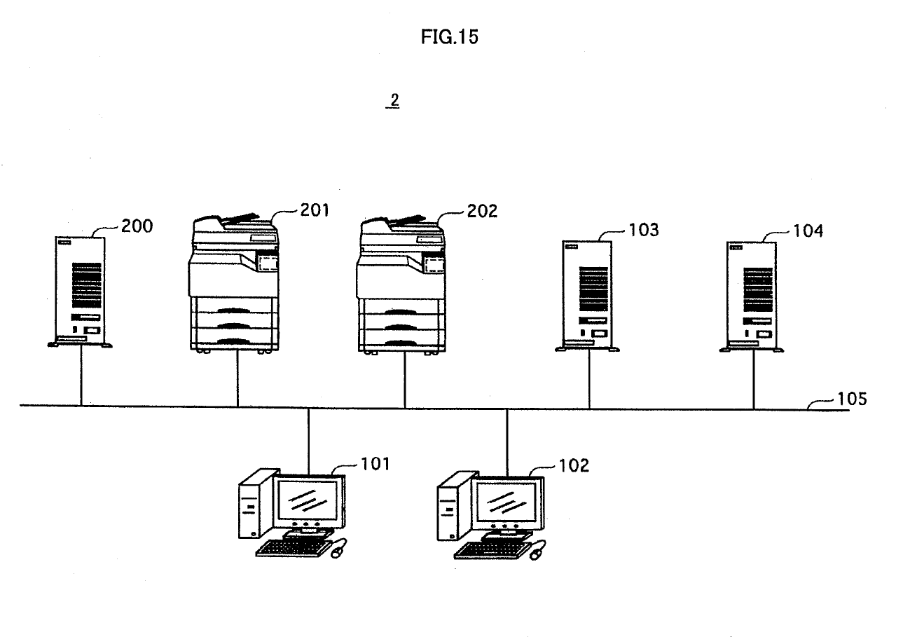

FIG. 14 is a flowchart showing the above-mentioned operations.

Upon receiving the billing ticket returned from the controller 14 in Step S1203 shown in FIG. 12 (Step S1401), the billing server 103 updates, in the balance management table stored in the billing management information storage 26, the balance of the user corresponding to the user ID notified from the controller 14 when the billing ticket is returned, to the amount of money obtained by adding the amount of money indicated by the returned billing ticket to the balance (Step S1402). Subsequently, the billing server 103 deletes the information pieces on the billing ticket (the billing ticket ID and the amount of money indicated by the billing ticket) from the balance management table and the billing ticker management table stored in the billing management information storage 26 (Step S1403).

In the first embodiment, the image forming apparatus 100 to execute the print job directly receives the print job transmitted from the PC, makes a request to the billing server 103 for issuance of the billing ticket of the print job, allocates the budgeted billing amount for the print job and executes the print job. However, a second embodiment is different from the first embodiment in that: a job management apparatus that does not directly execute the print job receives the print job, makes a request to the billing server 103 for the issuance of the billing ticket of the print job, and allocates the budgeted billing amount for the print job; and any of a plurality of image forming apparatuses acquires the print job and the billing ticket of the print job from the job management apparatus, and executes the print job.

The following mainly describes the difference between the first and second embodiments.

Structure

(1) Structure of Printing System 2

The following describes the printing system 2 pertaining to the second embodiment.

FIG. 15 shows an exemplary structure of the printing system 2 pertaining to the second embodiment.

As shown in FIG. 15, the printing system 2 is composed of a job management apparatus 200, image forming apparatuses 201 and 202, the PCs 101 and 102, the billing server 103 and the authentication server 104. The job management apparatus 200, the image forming apparatuses 201 and 202, the PCs 101 and 102, the billing server 103 and the authentication server 104 are connected to one another via the LAN 105.

In the above-described structure, elements that are the same as the elements of the printing system 1 in the first embodiment are provided with the same reference numerals, and the descriptions thereof are omitted.

Also, although the number of image forming apparatuses included in the printing system 2 is two in the above-described structure, the number of image forming apparatuses may be any number that is one or more.

(2) Structure of Job Management Apparatus 200

The job management apparatus 200 is a print job transfer server that receives the print job from the PCs 101 and 102, and transfers the received print job to the image forming apparatuses 201 and 202 in accordance with requests therefrom.

Note that the job management apparatus 200 may be an image forming apparatus including image forming functions.

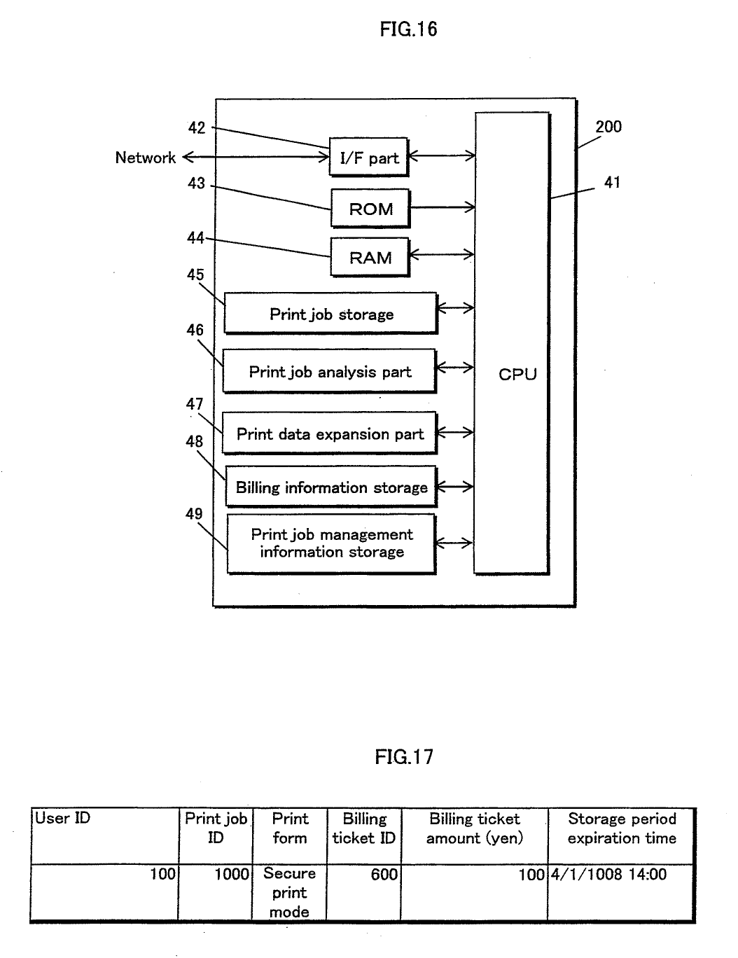

FIG. 16 shows a structure of the job management apparatus 200.

The job management apparatus 200 includes a CPU 41, a communication interface (I/F) part 42, a ROM 43, a RAM 44, a print job storage 45, a print job analysis part 46, a print data expansion part 47, a billing information storage 48 and a print job management information storage 49.

The I/F part 42 is an interface for connection with the LAN such as the LAN card and the LAN board.

The ROM 43 includes programs such as a program necessary for executing print job management processing (described later) and a program necessary for analyzing the print job.

The RAM 44 is used as a work area at the time of program execution by the CPU 41.

The print job storage 45, the print job analysis part 46, the print data expansion part 47 and the billing information storage 48 respectively have the same functions as the print job storage 146, the print job analysis part 147, the print data expansion part 148 and the billing information storage 149 that are included in the image forming apparatus 100 described in the first embodiment.

The print job management information storage 49 stores therein the print job management information.

The print job management information is information that is generated by the print job management apparatus 200 in the after-mentioned print job management processing, and shows a correspondence among: the user ID, the print job ID, the print form, the billing ticket ID, the amount of money indicated by the billing ticket and the storage period expiration time (calculated for the billing ticket). Here, the user ID, the print job ID and the print form are included in the received print job while the billing ticket ID and the amount of money indicated by the billing ticket are obtained for the print job from the billing server 103, and the storage period expiration time is calculated by the job management apparatus 200.

FIG. 17 shows a concrete example of the print job management information.

The CPU 41 reads, from the ROM 43, programs such as the program necessary for executing the after-mentioned print job management processing and the program necessary for analyzing the print job, and controls the execution of the operations of the print job management processing, for example.

(3) Structures of Image Forming Apparatuses 201 and 202

Each of the image forming apparatuses 201 and 202 acquires, from the job management apparatus 200, the print job and the billing ticket of the print job, and executes the acquired print job.

Each of the image forming apparatuses 201 and 202 is composed of the image processor 11, the paper feeder 12, the operation panel 13, the controller 24 and the image reader 15 (elements that are the same as the elements of the image forming apparatus 100 described in the first embodiment are provided with the same reference numerals).

The controller 24 has the same elements as the controller 14 of the image forming apparatus 100 except for the waiting print job storage 150, and performs transferred print job execution processing (described later).

Operations

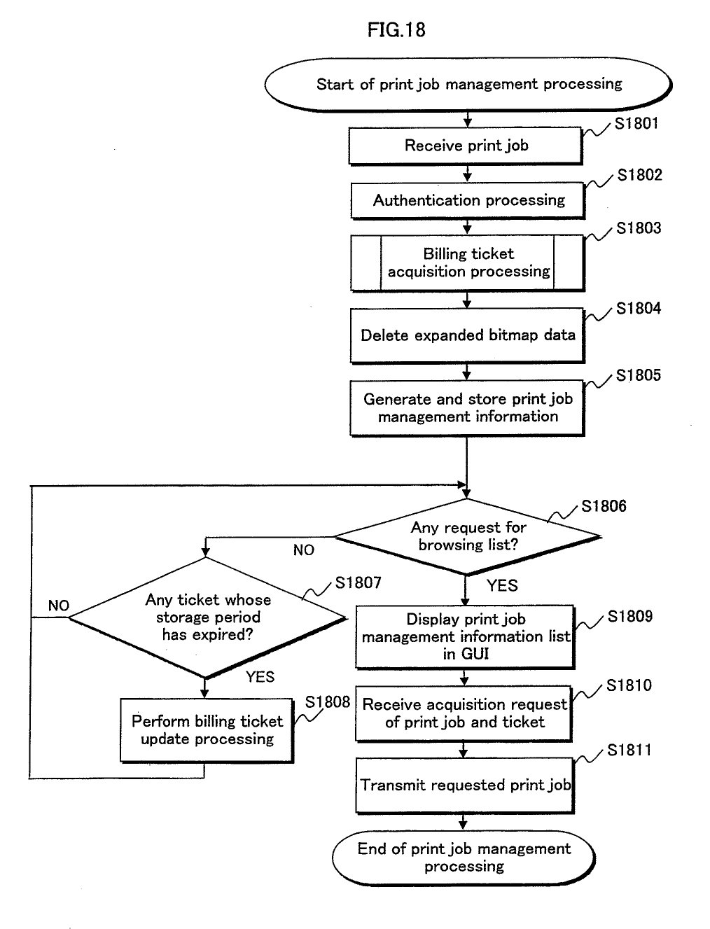

The following describes the operations of the print job management processing performed by the job management apparatus 200. FIG. 18 is a flowchart showing the above-described operations. Since processing of Step S1801 to Step S1802 shown in FIG. 18 are the same as the processing of Step S1001 to Step S1002 shown in FIG. 10, and processing of Step S1803 shown in FIG. 18 is the same as the billing ticket acquisition processing of Step S1005 shown in FIG. 10, for example, the descriptions of Steps 1801 to Step S1803 are omitted.

The job management server 200 deletes the bitmap data expanded in Step S1803 (Step S1804), and calculates the storage period expiration time of the acquired billing ticket in the same manner as the calculation performed by the controller 14 in the first embodiment (in the second embodiment, the storage period (e.g. five minutes) of the billing ticket is pre-specified for the “normal print mode” in addition to the secure print mode and the trial print mode, and the job management apparatus 200 calculates the storage period expiration time based on the storage period pre-specified for each print form). The job management apparatus 200 generates the print job management information showing the correspondence among the user ID (included in the received print job), the print job ID (included in the received print job), the print form (included in the received print job), the acquired billing ticket ID, the amount of money indicated by the billing ticket and the storage period expiration time calculated for the billing ticket, and stores the generated print job management information in the print job management information storage 49 (Step S1805). Subsequently, the job management apparatus 200 monitors whether or not the image forming apparatus 201 or 202 makes a request for browsing a list of the stored print job management information pieces (Step S1806).

When there is no browsing request (Step S1806: NO), the job management apparatus 200 acquires a current time, and compares the storage period expiration time of the billing ticket shown by each piece of the print job management information stored in the print job management information storage 49 with the current time to judge whether or not there is any billing ticket whose storage period has expired (Step S1807). When there is the billing ticket, the storage period of which has expired (Step S1807: YES), the job management apparatus 200 performs the billing ticket update processing (Step S1808). In the billing ticket update processing, the job management apparatus 200 notifies, via the I/F part 42, the billing server 103 of the user ID corresponding to the billing ticket, returns the billing ticket to the billing server 103, and deletes the information on the billing ticket (the billing ticket ID, the amount of money indicated by the billing ticket and the storage period expiration time) from the print job management information.

When there is the browsing request in Step S1806 (Step S1806: YES), the job management apparatus 200 reads the print job management information stored in the print job management information storage 49, transmits the read print job management information to the image forming apparatus that has made the browsing request, and displays the list of print job management information pieces in the GUI (Step S1809). Upon receiving, from the image forming apparatus, a request for acquiring the print job selected by the user from the list and the billing ticket of the corresponding print job (Step S1810), the job management apparatus 200 reads, from the print job storage 45, the print job requested to be acquired. When there is the billing ticket acquired for the print job (when the billing ticket is not deleted due to expiration of the storage period from the print job management information), the job management apparatus 200 transmits, to the image forming apparatus that has made the acquisition request, the print job and the billing ticket. When there is no billing ticket (when the billing ticket is deleted due to the expiration of the storage period from the print job management information), the job management apparatus 200 transmits only the print job to the image forming apparatus (Step S1811).

Note that when the billing server 103 notifies that the billing ticket cannot be issued in Step S1803, the print job management apparatus 200 terminates the print job management processing for the print job without proceeding to Step S1804.

The following describes operations of the transferred print job execution processing performed by the controller 24 of the image forming apparatus 201 or 202.

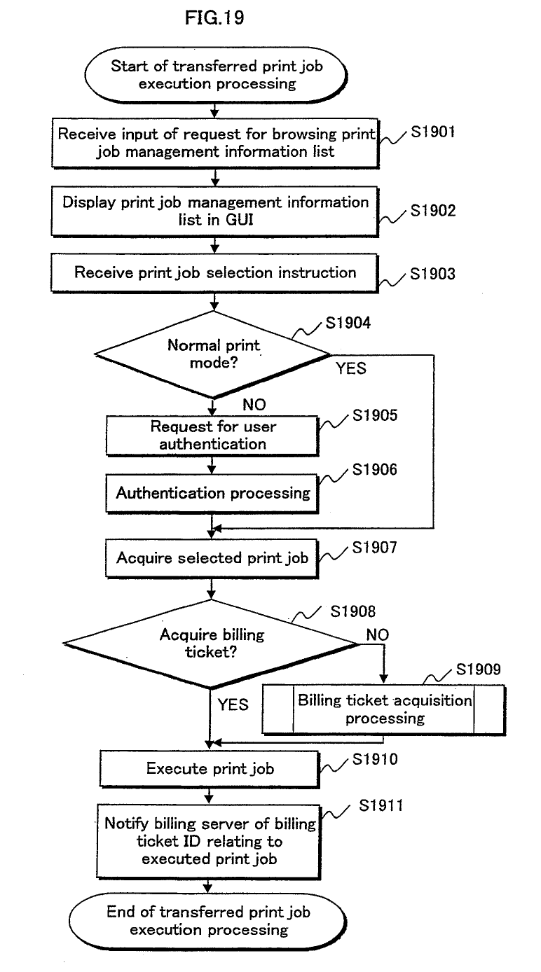

FIG. 19 is a flowchart showing the above-mentioned operations.

Upon receiving, from the user via the operation panel 13, an input of the browsing request of the list of the print job management information pieces stored in the job management apparatus 200 (Step S1901), the controller 24 transmits the browsing request to the job management apparatus 200. When the job management apparatus 200 performs the processing of Step S1809 shown in FIG. 18, and the controller 24 acquires the list of the print job management information pieces from the job management apparatus 200, the controller 24 causes the liquid crystal display part of the operation panel 13 to display the list in the GUI (Step S1902). Upon receiving a selection instruction of a print job and a billing ticket corresponding to the print job from the user via the operation panel 13 (Step S1903), the controller 24 judges whether or not the print form of the selected print job is the normal print mode (Step S1904). When the print form is not the normal print mode (when the print form is the secure print mode or the trial print mode, Step S1904: NO), the controller 24 causes the liquid crystal display part of the operation panel 13 to display the message that prompts the user to input authentication information to make a request for the user authentication (Step S1905). When the user inputs, from the operation panel 13, a user ID and a password included as user authentication information, the controller 24 notifies the authentication server 104 of the user authentication information, and makes a request for the authentication processing of the user. When the user is authenticated by the authentication server 104 (Step S1906), the controller 24 transmits, to the job management apparatus 200, a request for acquiring the selected print job and the billing ticket of the print job. Subsequently, the job management apparatus 200 performs processing of Step S1810 and Step S1811 shown in FIG. 18. The controller 24 acquires the print job and the billing ticket of the print job that are transmitted from the job management apparatus 200, or acquires only the print job transmitted from the job management apparatus 200 (Step S1907) when the billing ticket is returned.

Note that when the print form is the normal print mode in Step S1904 (Step S1904: YES), the controller 24 proceeds to processing of Step S1907.

Subsequently, when the controller 24 acquires the billing ticket of the print job (Step S1908: YES), the controller 24 executes the print job with use of the billing ticket, and causes the image forming apparatus to print an image based on the print data (Step S1910). Then, the controller 24 notifies the billing server 103 of the billing ticket ID relating to the executed print job (Step S1911).

When the controller 24 cannot acquire the billing ticket in Step S1908 (Step S1908: NO), the controller 24 proceeds to processing of Step S1910 after performing the same billing ticket acquisition processing as that of the FIG. 11 to acquire the billing ticket of the print job (Step S1909).

Note that when the user is not authenticated in the Step S1906 or when the billing server 103 notifies that the billing ticket cannot be issued in Step S1909, the controller 24 stops the execution of the print job, and terminates the transferred print job execution processing of the print job.

Supplementary Remarks

This concludes the description of the image forming apparatus pertaining to the present invention based on the embodiments. However, it is needless to say that the present invention is not limited to the above-described embodiments.

(1) Although the billing server 103 performs the billing ticket issuance processing and the issued billing ticket adjusting processing, and the authentication server 104 performs the user authentication in the first and second embodiments, one of these servers may perform all of the above-mentioned processing.

Specifically, one of the servers may include all of the billing information, the balance management table, the billing ticket management table and the user authentication management information so as to perform all of the above-mentioned processing as with the first and the second embodiments.

Also, the image forming apparatus 100 may perform all of the above-mentioned processing in the first embodiment, and the job management apparatus 200 may perform all of the above-mentioned processing in the second embodiment.

Specifically, each of the image forming apparatus 100 and the job management apparatus 200 may acquire, from the billing server 103, the billing information, the balance management table and the billing ticket management table, and perform the billing ticket issuance processing and the issued billing ticket adjusting processing as with the billing server 103. Furthermore, each of the image forming apparatus 100 and the job management apparatus 200 may acquire the user authentication management information from the authentication server 104 and perform the user authentication processing as with the authentication server 104.

Also, each of the image forming apparatus 100 and the job management apparatus 200 may store therein all of the billing information, the balance management table, the billing ticket management table and the user authentication management information, and perform all the above-mentioned processing as with both the billing server 103 and the authentication sever 104.

(2) In the first and second embodiments, the storage period expiration time of the billing ticket issued from the billing server 103 is specified according to the print form of the corresponding print job. However, the storage period expiration time may be specified according to an importance level of the print job.

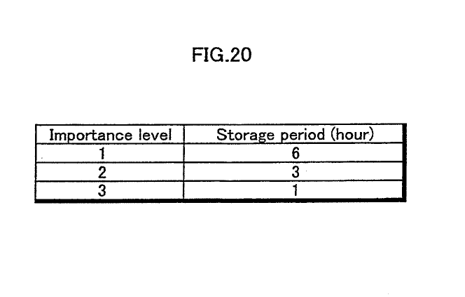

Specifically, the importance level (e.g. one of levels 1 to 3) may be set for each print job in the PCs 101 and 102 by a user input. The set level is written in the PJL, and is transmitted to the image forming apparatus 100 or the job management apparatus 200. In each of the image forming apparatus 100 and the job management apparatus 200 is stored a storage period specification table showing a correspondence between the importance level and the storage period of the billing ticket as shown in FIG. 20. The image forming apparatus 100 or the job management apparatus 200 may analyze the print job transmitted thereto, acquires the importance level of the print job, specify the storage period of the billing ticket issued from the billing server 103 for the print job, with reference to the storage period specification table, and calculate the storage period expiration time of the billing ticket as with the first and second embodiment to specify the storage period expiration time of the billing ticket.

Note that, according to this modification, the importance level is not input when the print form is the “normal print mode” in the first embodiment.

Also, the storage period of the billing ticket may not be specified in the first and second embodiments. In this case, the following processing does not have to be executed. The processing includes: the stored ticket update processing (Step S1012) shown in FIG. 10; the judgment processing of whether or not there is the billing ticket (Step S1014); the billing ticket acquisition processing (Step S1015); the judgment processing of whether or not the storage period of the billing ticket has expired (Step S1807) of FIG. 18; the billing ticket update processing (Step S1808); the judgment processing of whether or not the billing ticket has been acquired (Step S1908) shown in FIG. 19 and the billing ticket acquisition processing (Step S1909).

Thus, the print job can be reliably executed with the allocated billing ticket.

(3) In the print control processing shown in FIG. 10 of the first embodiment, the bitmap data expanded in the billing ticket acquisition processing is deleted in Step S1009, which prevents the storage area from being occupied by the bitmap data large in size for a long time, thereby resulting in effective use of the memory storage area of the image forming apparatus 100. However, the expanded bitmap data may be stored in the image forming apparatus 100 without deleting it, and the print job may be executed by causing the image forming apparatus to print the image based on the bitmap data corresponding to the print job when the execution instruction of the print job is given (Step S1011: YES) and the billing ticket of the print job is acquired.

Thus, once the print job to be executed has been expanded to the bitmap data (expanding processing of Step S1016 shown in FIG. 10) in the billing ticket acquisition processing, this expanding processing does not have to be performed again at the time of execution of the print job. This reduces processing load necessary for the expanding processing.

(4) The first and second embodiments do not describe processing for the billing ticket when the print job is interrupted partway through. When the print job is interrupted part way through the execution processing of the print job (Step S1016 shown in FIG. 10 or Step S1910 shown in FIG. 19), the controller 14 or the controller 24 calculates the billing amount corresponding to the number of copies that have been printed before the interruption, notifies the billing server 103 of an amount of money obtained by subtracting the calculated amount of money from the amount of money shown by the billing ticket of the print job, and adding the notified amount of money to the balance of the user in the balance management table.

Thus, the user can use the added amount of money for another print processing.

(5) In the first and second embodiments, the billing server 103 manages the amount of money for printing that is usable by the user with use of the balance of the amount of money for printing pre-provided to the user. However, the amount of money for printing that is usable by the user may be managed by obtaining a total amount of money that has been consumed each time the amount of money for printing is consumed for the execution of the print job, and monitoring whether or not the total amount of money that has been consumed exceeds the amount of money for printing allocated to the user.

(6) In the first and second embodiments, the user authentication processing is performed with use of the password. In another method, the user authentication processing may be performed with use of biological information such as a form of a finger print or a form of a vein of the user, for example. A visible light camera or an infrared camera, for example, may be used as a device for reading the biological information.

General Summary

The above-described first and second embodiments and supplemental remarks are for solving the problem described in the prior art section. With the above-mentioned structures, when a waiting print job that is kept from being executed until an execution instruction is inputted is received, a budgeted billing amount for the waiting print job is allocated regardless of whether the execution instruction of the print job is given. Therefore, it is possible to effectively avoid a situation that the waiting print job cannot be executed due to insufficiency of an amount of money for executing the waiting print job during a time between the print job being received and the execution instruction of which being received.

The image forming apparatus may further comprise: a valid period storage operable to store therein the allocated budget amount in correspondence with a valid period that is set therefor; a monitoring part operable to monitor the valid period stored in the valid period storage; and a cancellation part operable to cancel the allocation of the budget amount when the valid period has expired before the execution instruction is inputted.

The print method may further comprise: a valid period storage step of storing the allocated budget amount in correspondence with a valid period that is set therefor; a monitoring step of monitoring the valid period stored in the valid period storing step; and a cancellation step of canceling the allocation of the budget amount when the valid period has expired before the execution instruction is inputted.

In the printing system, the image forming apparatus may further include: a valid period storage operable to store therein the allocated budget amount in correspondence with a valid period that is set therefor; a monitoring part operable to monitor the valid period stored in the valid period storage; and a cancellation request part operable to make a cancellation request to the billing server for canceling the allocation of the budget amount when the set valid period has expired before the execution instruction is inputted, wherein the budget allocation part allows, upon receiving the cancellation request, the budget amount to be allocated to the another one or more print jobs.

Thus, when the budget amount has been remained allocated for a long time, the allocation of the budget amount is canceled. Therefore, it is possible to prevent the budget amount from being unnecessarily allocated for a long time due to an unexecuted and forgotten print job. The canceled budget amount can be used for executing another one or more print jobs that require the budget amount.

The valid period may be set according to the importance level of the waiting print job relating to the budget amount.

Thus, a length of the valid period of the budget amount relating to the waiting print job may be adjusted according to the importance level of the waiting print job. Therefore, a period in which the waiting print job can be executed may be provided as a long period for an important waiting print job by setting, as a long period, the valid period of the budget amount regarding the waiting print job. Meanwhile, the valid period of the budget amount regarding the waiting print job that is less important may be provided as a short period so that the budget amount can be used for executing another one or more print jobs. Thus, use of the allocated budget amount can be optimized.

Also, yet another aspect of the present invention is a printing system that includes a job management apparatus that receives at least one print job from a user and manages the print job, and a plurality of image forming apparatuses, at least one of which executes the print job, the job management apparatus comprising: a storage operable to store therein the received print job; a determination part operable to analyze the print job, and determine a billing amount of the print job based on a result of the analysis; and an allocation part operable to allocate, to the stored print job, a budget amount equivalent to the determined billing amount, each of the image forming apparatuses including: a receiver operable to receive an execution instruction for executing the stored print job; a request part operable to make a request to the job management apparatus for acquiring the stored print job and the allocated budget amount; and an execution part operable to execute the stored print job when the stored print job and the allocated budget amount have been acquired.

Thus, the print job received from the user is stored in the job management apparatus, and the budget amount for the print job is allocated by the job management apparatus. Therefore, the user can select the image forming apparatus suitable for executing the print job from among a plurality of image forming apparatuses, which causes the image forming apparatus to acquire, from the job management apparatus, the print job and the budget amount and to execute the print job.

### REFERENCE SIGNS LIST

1, 2 printing system

11 image processor

12 paper feeder

13 operation panel

14, 24 controller

15 image reader

21, 31, 41, 141 CPU

22, 32, 42, 142 I/F part

23, 33, 43, 143 ROM

24, 34, 44, 144 RAM

25, 48, 149 billing information storage

26 billing management information storage

35 authentication information storage

45, 146 print job storage

46, 147 print job analysis part

47, 148 print data expansion part

49 print job management information storage

100, 201, 202 image forming apparatus

101, 102 PC

103 billing server

104 authentication server

105 LAN

150 waiting print job storage

200 job management server

1. An image forming apparatus that executes a waiting print job and charges for the execution of the waiting print job, the waiting print job being a print job that is inputted by a user and kept from being executed until an execution instruction is inputted by the user, the image forming apparatus comprising:
a determination part operable, when the waiting print job is inputted, to analyze the waiting print job and determine a billing amount of the waiting print job based on a result of the analysis;
an allocation part operable to allocate, for the waiting print job, a budget amount equivalent to the determined billing amount; and
an execution part operable, when the execution instruction is inputted and the budget amount has been allocated, to perform the execution, wherein
when the waiting print job is inputted, the allocation part performs the allocation regardless of whether the execution instruction is inputted.

2. The image forming apparatus of claim 1, wherein
the determination part includes:
an analysis subpart operable to perform the analysis;
an expansion subpart operable to expand the waiting print job to data for printing; and
a calculation subpart operable to calculate the billing amount of the waiting print job based on the result of the analysis and a result of the expansion.

3. The image forming apparatus of claim 1, further comprising:
a valid period storage operable to store therein the allocated budget amount in correspondence with a valid period that is set therefor;
a monitoring part operable to monitor the valid period stored in the valid period storage; and
a cancellation part operable to cancel the allocation of the budget amount when the valid period has expired before the execution instruction is inputted.

4. The image forming apparatus of claim 3, wherein
the valid period is set according to an importance level of the waiting print job.

5. A printing system that includes a billing server that manages an upper limit of an amount of money that is set for each user and is for executing one or more print jobs inputted by the user, and an image forming apparatus that executes a waiting print job and causes the billing server to charge for the execution of the waiting print job, the waiting print job being a print job that is, after being inputted, kept from being executed until an execution instruction is inputted by the user,
the image forming apparatus comprising:
a determination part operable, when the waiting print job is inputted, to analyze the waiting print job and determine a billing amount of the waiting print job based on a result of the analysis;
an allocation request part operable to make an allocation request to the billing server for allocating, for the waiting print job, a budget amount equivalent to the determined billing amount; and
an execution part operable, when the execution instruction is inputted and the budget amount has been allocated by the billing server, to perform the execution,
the billing server comprising:
a budget allocation part operable, upon receiving the allocation request from the image forming apparatus, to judge whether or not a sum of budget amounts that have been allocated and the budget amount to be allocated exceeds the set limit, and when judging negatively, allocate the budget amount so as not to be used for executing another one or more of the print jobs other than the waiting print job; and
a notification part operable to notify the image forming apparatus of whether or not the budget amount is allocated for the waiting print job, wherein
when the waiting print job is inputted, the allocation request part makes the allocation request regardless of whether the execution instruction is inputted.

6. The printing system of claim 5, wherein
the determination part includes:
an analysis subpart operable to perform the analysis;
an expansion subpart operable to expand the waiting print job to data for printing; and
a calculation subpart operable to calculate the billing amount of the waiting print job based on the result of the analysis and a result of the expansion.

7. The printing system of claim 5, wherein
the image forming apparatus further includes:
a valid period storage operable to store therein the allocated budget amount in correspondence with a valid period that is set therefor;
a monitoring part operable to monitor the valid period stored in the valid period storage; and
a cancellation request part operable to make a cancellation request to the billing server for canceling the allocation of the budget amount when the set valid period has expired before the execution instruction is inputted, wherein
the budget allocation part allows, upon receiving the cancellation request, the budget amount to be allocated to the another one or more print jobs.

8. The printing system of claim 7, wherein
the valid period is set according to an importance level of the waiting print job.

9. A printing system that includes a job management apparatus that receives at least one print job from a user and manages the print job, and a plurality of image forming apparatuses, at least one of which executes the print job,
the job management apparatus comprising:
a storage operable to store therein the received print job;
a determination part operable to analyze the print job, and determine a billing amount of the print job based on a result of the analysis; and
an allocation part operable to allocate, to the stored print job, a budget amount equivalent to the determined billing amount,
each of the image forming apparatuses including:
a receiver operable to receive an execution instruction for executing the stored print job;
a request part operable to make a request to the job management apparatus for acquiring the stored print job and the allocated budget amount; and
an execution part operable to execute the stored print job when the stored print job and the allocated budget amount have been acquired.

10. A print method used in an image forming apparatus, the print method comprising:
a determination step of, when a user inputs a waiting print job that is kept from being executed until an execution instruction is inputted by the user, analyzing the waiting print job, and determining a billing amount of the waiting print job based on a result of the analysis;
an allocation step of allocating, for the waiting print job, a budget amount equivalent to the determined billing amount; and
an execution step of executing, when the execution instruction is inputted and the budget amount is allocated, the waiting print job, wherein
when the waiting print job is inputted, the allocation step performs the allocation regardless of whether the execution instruction is inputted.

11. The print method of claim 10, wherein
the determination step includes:
an analysis substep of performing the analysis;
an expansion substep of expanding the waiting print job to data for printing; and
a calculation substep of calculating the billing amount based on the result of the analysis and a result of the expansion.

12. The print method of claim 10, further comprising:
a valid period storage step of storing the allocated budget amount in correspondence with a valid period that is set therefor;
a monitoring step of monitoring the valid period stored in the valid period storing step; and
a cancellation step of canceling the allocation of the budget amount when the valid period has expired before the execution instruction is inputted.

13. The print method of claim 12, wherein
the valid period is set according to an importance level of the waiting print job.
